(19) United States
(12) Patent Application Publication
(10) Pub. No.: US 2008/0176036 A1
(43) Pub. Date: Jul. 24, 2008

(54) MICRO-PERFORATED LAMINAE AND METHOD

(76) Inventor: Melvin G. Mitchell, Penrose, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/956,098

(22) Filed: Dec. 13, 2007

Related U.S. Application Data
(63) Continuation-in-part of application No. 10/827,793, filed on Apr. 20, 2004, now abandoned.
Application No. 10/827,793 is a continuation-in-part of application No. 10/597,612, filed on Aug. 1, 2006.
(60) Provisional application No. 60/465,741, filed on Apr. 25, 2003.
(60) Provisional application No. 60/687,676, filed on Jun. 6, 2005.

(51) Int. Cl. B32B 3/24; B29C 45/14

(52) U.S. Cl. 428/136; 264/153; 428/131; 428/137

(57) ABSTRACT

A micro-perforated laminae includes a layer of material having a plurality of spaced-apart perforations, in which the total open orifice area of the perforations is about 0.1% to 100.0% of the total surface area of the layer of material. The layer of material can be a thermoplastic material, metal foil, cellulosic film, woven, paper and/or nonwoven. The perforations can be slits, with each slit having a length of no more than about 120 mils (3.0 mm). The total open orifice area of perforations can be in the range of about 0.1 mm² to about 100 mm² per square centimeter of the total surface area of the micro-perforated laminae. The two surfaces of the micro-perforated laminae may be surface treated to alter surface energy. The micro-perforated laminae can be used singularly or in combinations with multiple layers which in themselves may or may not contain micro-perforations and surface treatments. The micro-perforated laminae can be used with multiple layers that in themselves may be porous such as woven, paper and/or nonwoven. The layers of micro-perforated laminae thus constructed can be laminated using lower melt point adhesives or polymers which will allow the vents to open when under pressure and heat. Upon cooling of this same laminae the lower melt point adhesives or polymers will allow the vents to reseal.

This application is a continuation-in-part of U.S. application Ser. No. 10/827,793, filed Apr. 20, 2004, which claims priority to U.S. Provisional Application No. 60/465,741, filed Apr. 25, 2003. This application is also a continuation-in-part of U.S. application Ser. No. 10/597,612, filed Aug. 1, 2006, which is a national stage application of International Application No. PCT/US06/022063, filed Jun. 6, 2006, which claims priority to U.S. Provisional Application No. 60/687,676, filed Jun. 6, 2005.

### TECHNICAL FIELD AND BACKGROUND OF THE INVENTION

A micro-perforated laminae according to the invention can include a layer of material having a plurality of spaced-apart perforations, in which the total open orifice area of the perforations is about 0.1% to 100.0% of the total surface area of the layer of material. The layer of material can be a thermoplastic material, metal foil, cellulosic film, woven, paper and/or nonwoven. The perforations can be slits, with each slit having a length of no more than about 120 mils (3.0 mm). The total open orifice area of perforations can be in the range of about 0.1 mm² to about 100 mm² per square centimeter of the total surface area of the micro-perforated laminae. The two surfaces of the micro-perforated laminae may be surface treated to alter surface energy. The micro-perforated laminae can be used singularly or in combinations with multiple layers which in themselves may or may not contain micro-perforations and surface treatments. The micro-perforated laminae can be used with multiple layers that in themselves may be porous such as woven, paper and/or nonwoven. The layers of micro-perforated laminae thus constructed can be laminated using lower melt point adhesives or polymers having a melting point of about 130 to 210 degrees Fahrenheit which will allow the vents to open when under pressure and heat. Upon cooling of this same laminae the lower melt point adhesives or polymers will allow the vents to reseal.

Such materials may find extensive uses in many products and technologies, as described below.

### SUMMARY OF THE INVENTION

Therefore, it is an object of the invention to provide micro-perforated laminae that permit controlled passage of a gas without passage of a liquid.

It is another object of the invention to provide micro-perforated laminae that permit controlled passage of gas and liquid from one side to another of the laminae, but in the reverse direction permit controlled passage of a gas without passage of a liquid (one way valve).

It is another object of the invention to provide a method of micro-perforating laminae so as to permit controlled passage of a gas without passage of a liquid.

It is another object of the invention to provide a method of micro-perforating laminae so as to permit controlled passage of gas and liquid from one side to another of the laminae.

These and other objects are achieved in the examples set out in this application by providing a layer of material defining a total surface area and having a plurality of spaced-apart perforations defining a total open orifice area, in which the total open orifice area when fully opened comprises about 0.1% to 100.0% + of the total surface area of the layer.

According to a preferred embodiment of the invention, the layer of material comprises a thermoplastic material, metal foil, cellulosic film, woven, paper and/or nonwoven.

According to a preferred embodiment of the invention, the perforations are slits, and each slit has a length of no more than about 120 mils.

According to yet another preferred embodiment of the invention, the total open orifice area is in the range of about 0.1 mm² to about 100 mm² per square centimeter of the total surface area.

According to yet another preferred embodiment of the invention, the layer of material is polypropylene, polyethylene, polyethylene terephthalate, nylon 6, nylon 66, polycarbonate, polyethylene terephthalate glycol, high impact polystyrene, polyacrylonitrile-butadiene-styrene or polyacrylate, polytetrafluoroethylene, polyvinylfluoride, polyvinylchloride, chloride, polyvinylidenefluoride, cellulose acetate, polyvinylidenechloride, linear low density polyethylene, low density polyethylene, aluminum foil or any continuous film material used singularly or in multiple layers.

According to yet another preferred embodiment of the invention, the micro-perforated layer includes a thermoplastic material, metal foil, cellulosic film, woven, paper and/or nonwoven. , or any combination thereof.

According to yet another preferred embodiment of the invention, the micro-perforated laminae has a weight of between 8 g/m² and 680 g/m².

According to yet another preferred embodiment of the invention, the micro-perforated laminae simultaneously retains liquid and vents gas.

According to yet another preferred embodiment of the invention, the micro-perforated laminae has first and second sides, and retains a predetermined level of water on the first side while allowing a predetermined level of liquid to pass through to the second side.

According to yet another preferred embodiment of the invention, the micro-perforated laminae retains about 25-60 centimeters of static water head on the first side.

According to yet another preferred embodiment of the invention, the first and second sides of the laminae have a contact angle of water in the range of about 36 to 42 degrees.

According to yet another preferred embodiment of the invention, the layer of material is mechanically micro-perforated, and the perforations are micro-slits having a length of about one to three millimeter each, and are spaced-apart on the thermoplastic layer at a density per square area ranging from 10 cm centers to 0.5 mm centers.

According to yet another preferred embodiment of the invention, the micro-perforated laminae includes a flat, patterned or laminated layer.

According to yet another preferred embodiment of the invention, the micro-perforated laminae has two sides, and one side has a silicone release coating.

According to yet another preferred embodiment of the invention, the micro-perforated laminae has two sides. One side has a contact angle of water of about 38 degrees, and the other side has a contact angle of water of about 60 degrees.

According to yet another preferred embodiment of the invention, a method of making a micro-perforated laminae includes providing a layer of material defining a total surface area, and micro-perforating the layer of material to form a plurality of spaced-apart perforations defining a total open orifice area. The total open orifice area is about 0. 1% to 100.0% of the total surface area of the layer.

According to yet another preferred embodiment of the invention, a method of making a micro-perforated laminae includes providing a layer of polypropylene, polyethylene, polyethylene terephthalate, nylon 6, nylon 66, polycarbonate, polyethylene terephthalate glycol, high impact polystyrene, polyacrylonitrile-butadiene-styrene, polyacrylate, polytetrafluoroethylene, polyvinylfluoride, polyvinylchloride, chloride, polyvinylidenefluoride, cellulose acetator, polyvinylidenechloride, linear low density polyethylene or low density polyethylene, foil or a combination of any continuous film material. The layer of material is micro-perforated to form a plurality of micro-slits having a length of about 1-3 mm each spaced-apart on the thermoplastic layer at a density per square area ranging from 10 cm centers to 0.5 mm centers. The micro-slits define a total open orifice area that includes about 0.1% to 100.0% of the total surface area of the layer.

According to yet another preferred embodiment of the invention, the micro-perforated laminae provides simultaneous controllable liquid retention and controllable gas/vapor venting characteristics. In perforating a continuous layer, the invention includes the steps of providing a thermoplastic film, foil, web or sheet and perforating the layer with micro-perforations such that the layer can hold back more than 25-60 centimeters of static water head above the wetted surface. The micro-orifices in the film pass a controllable level of liquid through to the air “dry side” of the film. Although no liquid leakage will be observed into air from a micro-perforated lamina attached in either direction to the static liquid head device, placement of this lamina against another object may immediately cause wicking or weeping by capillary action into that substrate. The degree of wicking or weeping is indirectly proportional to the contact angle of the liquid on the surface of the dry side of the film. That is, no wicking or wetting will occur with a high contact angle, low dyne level, (hydrophobic) dry side. Conversely, ready liquid availability is present for a low contact angle, high dyne level, (hydrophilic) dry side. The wetted side liquid contact angle appears to have negligible effect on the degree of wicking or weeping to the dry side. The micro-perforated laminae can either be used singularly or in conjunction with multiple layers which also may or may not contain micro-perforations in order to expand end use applications.

### BRIEF DESCRIPTION OF THE DRAWINGS

FIG. 1 is an enlarged perspective view of a blown, post-embossed, low density polypropylene film having a 1 mm long microslit formed therein;

FIG. 2 is an enlarged perspective view of a blown, clear, low density polypropylene film having a 1 mm long microslit formed therein; and

FIG. 3 is an enlarged perspective view of a blown, low density polypropylene film having a 1 mm long microslit formed therein, with a silicone release applied to one side thereof.

### DETAILED DESCRIPTION OF PREFERRED EMBODIMENTS AND BEST MODE

A method of forming a micro-perforated laminae, such as a film, foil, web or sheet with simultaneous controllable liquid retention and gas/vapor venting characteristics according to a preferred embodiment of the invention is disclosed below. The method includes the steps of providing a layer of thermoplastic material, such as a film, foil, web or sheet, and micro-perforating the film, foil, web or sheet with perforations. The perforations are spaced from each other so that the total open orifice area can range from 0.1 mm² to 100 mm² per cm² total film or 0.1% to 100 open orifice based upon total surface area. The perforations can be of various shapes, including slits having a length of no more than 120 mils (3.0 mm). The perforations are preferably formed using a mechanical process, which is conducive to providing suitable sized perforation.

The film, foil, web or sheet is preferably polypropylene (PP), polyethylene (PE), polyethylene terephthalate (PET), nylon 6 (N6), nylon 66 (N6,6), polycarbonate (PC), polyethylene terephthalate glycol (PETG), high impact polystyrene (HIPS), polyacrylonitrile-butadiene-styrene (ABS) or polyacrylate, polytetrafluoroethylene (PTFE), polyvinylfluoride (PVF), polyvinylchloride (PVC), chloride (CPVC), polyvinylidenefluoride (PVDF), polyvinylidenechloride (PVDC), cellulose acetate, or another suitable continuous film material. The film, foil, web or sheet preferably has a weight of between 8 g/m² (0.25 oz/yd²) and 680 g/m² (20.0 oz/yd²). The thermoplastic material, metal foil, cellulosic film, woven, paper and/or nonwoven may need a surface coating treatment to alter the surface energy. Suitable surface coating/ treatments include silicone, fluorocarbon, acrylic, corona treatment, flame treatment, and polyurethane.

The micro-perforated film, foil web or sheet has simultaneous liquid retention and gas/vapor venting characteristics. The micro-perforated or microslit film, web or sheet will easily hold back 25-60 centimeters of static water head above the film, web or sheet while passing a controllable level of liquid through to the air “dry side” of the film.

The degree of wicking or weeping is indirectly proportion to the contact angle of the liquid on the surface of the dry side of the film. No wicking or wetting will occur with a high contact angle, low dyne level (hydrophobic) dry side, but with ready liquid availability for wicking and wetting for a low contact angle, high dyne level (hydrophilic) dry side.

Untreated thermoplastic materials generally have a relatively moderate dyne level of about 25-31 and contact angle of about 35-40. When treated with corona, flame or a chemical primer, the dyne level of thermoplastic material typically increases to about 45-55, and the contact angle increases to about 60 or more. Thermoplastic materials treated with silicone or fluorocarbon typically have a relatively low dyne level of about 8-12, and a contact angle of about 25 or less. Thermoplastic material having a low dyne level of about 8-12 is hydrophobic, and water will not flow to the material. Water will flow to thermoplastic materials having a moderate dyne level of about 25-31 if the water is contacted. Finally, thermoplastic materials having a high dyne level of about 45-55 have such hydrophillic characteristics that water will readily flow in open air to the materials. As such, a micro-perforated laminae having a layer of low dyne level material on the wet side contacting the water, and a layer of high dyne level material on the opposite dry side provides a one-way valve type laminae, in which gas and liquid are allowed to pass from the wet side to the dry side of the laminae, but liquid is not allowed to pass in the reverse direction from the dry side to the wet side. The laminae does allow for the controlled passage of gas from the dry side to the wet side.

The films, foils, webs and sheets are adaptable for many uses, including absorbent back sheets: adult incontinent, baby diapers, and feminine hygiene; wound dressings; breathable water proof bandages, and artificial skin; agricultural/horticultural covers: row crop covers, tarpaulins, greenhouse covers; construction wraps: house wrap, replacement for extensible kraft on fiber glass insulation, roofing barriers; breathable storage cases: gun cases, duffle bags, back packs, tent or portable shelter storage bags; recreational or military protective coverings: tents, tarpaulins, shelters; agricultural/horticultural packaging: produce packaging, live plants, live animals (chickens, reptiles, amphibians, etc . . . ); breathable storage and transport cases for aquatic life: fish, plants, lobsters, invertebrates where oxygen can migrate into the water for aeration; aqualungs: helmets or containers with filtration systems for underwater containment of living organisms which require oxygen and CO2 diffusion across the membrane; attached or floatable breathing filtration system for snorkeling; filtration systems for submarines; medical/biological membranes for nourishment or protection; packaging for medical devices; chemical reaction membranes for gas diffusion into liquids; liquid waste treatment aeration system for introduction of air for reduction of BOD; processing aid for lamination of two or more previously nonporous webs with water or solvent based adhesives; liners: clothing liners, footwear liners, casket liners, water proof gloves, waterproof socks, hats, hoods; surgical garments and barriers where breathing is an advantage for comfort yet sterile protection from liquids: drapes, surgical gowns, surgical caps, plastic medical barriers; geo-textile barriers; and landfill barriers.

The thermoplastic material, metal foil, cellulosic film, woven, paper and/or nonwoven are also applicable to a wide range of clothing and apparel items, including rain, sports and athletic clothing, such as coats, pants, hats and undergarments, and industrial garments where breathing is an advantage for comfort, yet protection from hazardous liquids is necessary or desirable.

The thermoplastic material, metal foil, cellulosic film, woven, paper and/or nonwoven also have application in desiccant packaging; food packaging evaporation/concentration containers, packages or pipes to allow liquid vapor removal, therefore increasing concentration of other contents liquid or solid; porous packaging which will allow filling with ingredients while allowing air to be displaced through membrane; overcover protective membranes for air release as wall coverings, equipment coverings, adhesive labels and the like are being covered.

The films, foils, webs and sheets are also suitable as waterproof and water resistant barriers with reduced wind drag; signage, banners, walls; humidification containers, packaging or piping; slow release watering devices for plants; cook-in bags for off-gassing, browning and moisture removal without pressurization; automotive coverings: convertible tops and car covers.

Additional medical applications include radially perforated contact lenses for improved breathability and blood oxygenation systems. The following examples set forth embodiments of the laminae and methods described above.

### EXAMPLE 1

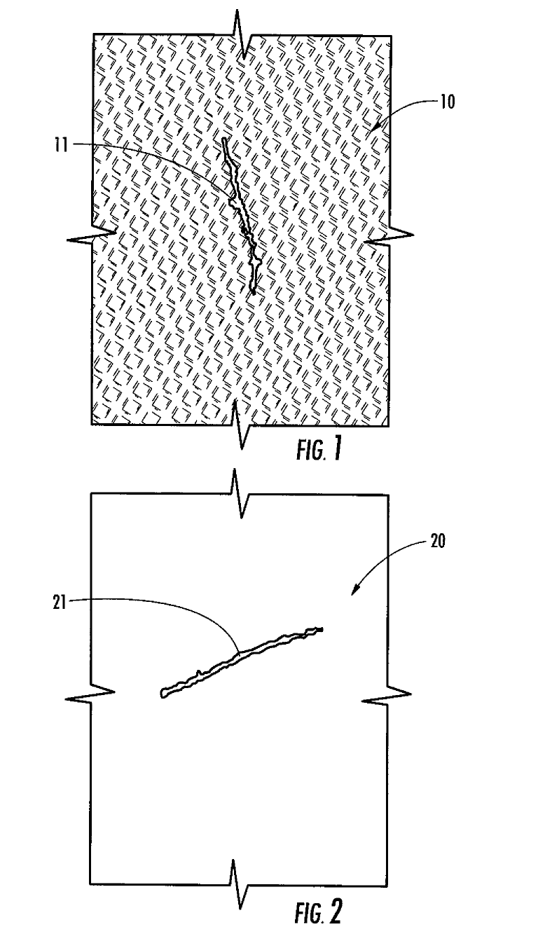

An example of a micro-perforated laminae according to a preferred embodiment of the invention is illustrated in FIG. 1, and shown generally at reference numeral 10. A Blown Post Embossed (diamond micropattern) film containing a blend of Linear Low Density Polyethylene (LLDPE) and Low Density Polyethylene (LDPE) is particularly suited for diaper backsheet and barrier film applications, and was obtained from Tredegar Film Products. The film had a 1.1 mil average gauge and a 1.65 mil embossed gauge. The film was mechanically micro-perforated with micro-slits 11, that are 1 mm each in length. The slit density per square area ranged from slits on 2.0 cm centers to 0.5 cm centers. Moisture Vapor Transfer Rate (MVTR) and Gurley Porosity were measured for each condition. Test results follow:

### Perforated Film Testing

| | | MVTR* | OPEN | |
|---|---|---|---|---|
| | | (gr/100 | AREA | POROSITY** |
| SAMPLE | DESCRIPTION | in²/day) | (mm²/cm²) | (secs) |
| A | 1 mm slits on 2 cm | N/A | 0.08 | 106.8 |
| | centers | | | |
| B | 1 mm slits on 1 cm | N/A | 0.32 | 36.9 |
| | centers | | | |
| C | 1 mm slits on 0.5 | N/A | 1.27 | 18.4 |
| | cm centers | | | |
| D | No perforation - | 1.251 | 0 | N/A |
| | control | | | |

*Moisture Vapor Transfer Rate - N/A = Off scale on instrument for high flow. 1.251 gr/100 in²/day = Extremely low MVTR
**Gurley Densometer - Seconds for weighted column of air 100 ccm to pass.

As can be readily observed, porosity of a film that has been micro-slit can be adjusted as required from non porous to extremely porous. Film tested at all micro-slit conditions were off scale of the MVTR test showing a very high passage rate of moisture. All samples with conditions described in the preceding table of micro-slit film were then attached to a container which provided 25-60 cm of static water head above the film when inverted. No leakage was observed from film attached in either direction to the static water head device. The subject samples were also rubbed manually whilst under pressure with again no leakage.

With differing conditions of spacing of the perforations, a variety of open orifice area films may be produced so that the total open orifice area can range from 0.1 mm² to 100 mm² per cm² total film or 0.1% to 100% open orifice based upon total surface area. The micro-perforated or micro-slit film can easily hold back 25-60 cm of static water head above the film when inverted. No leakage was observed from film attached in either direction to the static water head device. The subject film was also rubbed manually while under pressure, again with no leakage.

Although no liquid leakage will be observed into air from a web or onto finger tips when this film was attached in either direction to the static liquid head device, placement of this web against toweling or tissue will immediately cause capillary action wicking or weeping into that substrate. The contact angle of water onto both sides of the subject film was 36-38°.

### EXAMPLE 2

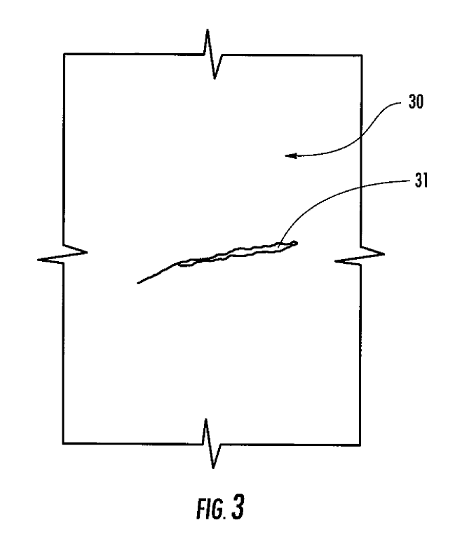

An example of a micro-perforated laminae according to another preferred embodiment of the invention is illustrated in FIG. 2, and shown generally at reference numeral 20. A blown LDPE specifically designed for SC Johnson Ziploc™ was mechanically micro-perforated with micro-slits 21 having a length of 1 mm each, and a slit 21 density per square area on 0.5 cm centers was performed to two films. Each film was separately placed in a static head device and held back ten inches of water. Although no liquid leakage will be observed into air from a web or onto finger tips when single films were attached in either direction to the static liquid head device, placement of this web against toweling or tissue immediately caused capillary action wicking or weeping into that substrate. Placement of two films onto the static head device cause water to wick onto the surface of the second film, but no water to flow through the second film into the air. Placement of the two webs against toweling or tissue caused very slow capillary action wicking or weeping into that substrate. The contact angle of water onto both sides of the subject film was ˜42°.

The same two films were then placed over the end of a plastic pipe with a 2 inch diameter and held in place with a rubber band. The films in relationship to each other were loosely held. The pipe was then placed alternately under vacuum and pressure with air transfer freely through the two films. The pipe with film end down was then placed into water five inches deep. The pressure of the water forced both films together. The two films would not pass water under vacuum. The films would pass air into the water under pressure. Once the pipe was removed from the water, the air could be transferred through the films alternately under vacuum and pressure.

Neither single nor double layers of film would pass water to the air side under five inches of water when not alternately under external vacuum and pressure.

### EXAMPLE 3

An example of a micro-perforated laminae according to yet another preferred embodiment of the invention is illustrated in FIG. 3, and shown generally at reference numeral 30. A blown LDPE particularly suited for Procter & Gamble Always Thin Ultra Feminine Hygiene pad covers was mechanically micro-perforated with micro-slits having a length of 1 mm each, with a slit density per square area on 0.5 cm centers. The film was two sided: one side with normal LDPE, and the other side with a silicone release coating. The contact angle of water onto the LDPE side was 38° onto the silicone release coating side was 60°. The film when placed static head device with either side to the water held back ten inches of water.

Although no liquid leakage was observed into air from a web or onto finger tips when single films were attached in either direction to the static liquid head device, placement of this web with the silicone side to the water and the LDPE side against toweling or tissue immediately caused capillary action wicking or weeping into that substrate. Placement of the film in reverse order to the static head device with the LDPE against the water and the silicone side to the air when placed against toweling or tissue would not allow capillary action wicking or weeping into that substrate. This micro-perforated laminae 30 exhibits properties of a one way check valve.

The degree of wicking or weeping is indirectly proportional to the contact angle of the liquid on the surface of the dry side of the film. That is, no wicking or wetting will occur with a high contact angle, low dyne level (hydrophobic) dry side. Conversely, ready liquid availability is present for a low contact angle, high dyne level (hydrophilic) dry side. The wetted side liquid contact angle appears to have negligible effect on the degree of wicking or weeping to the dry side.

A process for micro-perforating film and a micro-perforated film product is disclosed above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

What is claimed is:

1. A micro-perforated laminae having simultaneous liquid retention and gas venting capability, comprising a layer of material defining a total surface area and having a plurality of spaced-apart perforations defining a total open orifice area, wherein the total open orifice area comprises about 0.1% to 99.9% of the total surface area of the layer.

2. A micro-perforated laminae according to claim 1, wherein the perforations comprise slits each having a length of no more than about 120 mils (3.0 mm).

3. A micro-perforated laminae according to claim 1, wherein the total open orifice area is in the range of about 0.1 mm² to about 100 mm² per square centimeter of the total surface area.

4. A micro-perforated laminae according to claim 1, wherein the layer of material comprises at least one material selected from the group consisting of polypropylene, polyethylene, polyethylene terephthalate, nylon 6, nylon 66, polycarbonate, polyethylene terephthalate glycol, high impact polystyrene, polyacrylonitrile-butadiene-styrene, polyacrylate, polytetrafluoroethylene, polyvinylfluoride, cellulose acetate, polyvinylchloride, chloride, polyvinylidenefluoride, polyvinylidenechloride, linear low density polyethylene and low density polyethylene.

5. A micro-perforated laminae according to claim 1, wherein the layer of material comprises at least one selected from the group consisting of a thermoplastic material, metal foil, cellulosic film, woven, paper and/or nonwoven.

6. A micro-perforated laminae according to claim 5, wherein the micro-perforated laminae has a weight of between 8 g/m² and 680 g/m².

7. A micro-perforated laminae according to claim 1, wherein the micro-perforated laminae simultaneously retains liquid and vents gas.

8. A micro-perforated laminae according to claim 1, wherein the layer of material comprises one or more selected from the group consisting of a thermoplastic material, metal foil, cellulosic film, woven, paper and/or nonwoven.

9. A micro-perforated laminae according to claim 1, wherein the micro-perforated laminae defines first and second sides, and retains a predetermined level of water on the first side while allowing a predetermined level of liquid to pass through to the second side.

10. A micro-perforated laminae according to claim 9, wherein the micro-perforated laminae retains about 25-60 centimeters of static water head on the first side.

11. A micro-perforated laminae according to claim 9, wherein the first and second sides have a contact angle of water in the range of about 36 to 42 degrees.

12. A micro-perforated laminae according to claim 1, wherein the layer of material is mechanically micro-perforated, and the perforations comprise micros-slits having a length of about one millimeter each and are spaced-apart on the layer at a density per square area ranging from 10 cm centers to 0.5 mm centers.

13. A micro-perforated laminae according to claim 12, wherein the layer of material comprises a diamond micropattern film.

14. A micro-perforated laminae according to claim 13, wherein the film comprises linear low density polyethylene and low density polyethylene.

15. A micro-perforated laminae according to claim 1, wherein the layer of material is mechanically micro-perforated, and the perforations comprise micros-slits having a length of about one millimeter each and are spaced-apart on the thermoplastic layer at a density per square area of 0.2 cm centers.

16. A micro-perforated laminae according to claim 15, wherein the layer of material comprises low density polyethylene.

17. A micro-perforated laminae according to claim 16, wherein the micro-perforated laminae defines first and second sides, and the second side has a silicone release coating.

18. A micro-perforated laminae according to claim 17, wherein the first side has a contact angle of water of about 38 degrees, and the second side has a contact angle of water of about 60 degrees.

19. A micro-perforated laminae comprising:
(a) a first layer of a hydrophobic thermoplastic material;
(b) a second layer of a hydrophyllic thermoplastic material, whereby liquid on the first layer is allowed to pass through the laminae and liquid on the second layer is not allowed to pass through the laminae.

20. A micro-perforated laminae according to claim 19, wherein the first layer has a dyne level of about 8 to 12, and the second layer has a dyne level of about 45 to 55.

21. A method of making a micro-perforated laminae comprising the steps of:
(a) providing a layer of material defining a total surface area; and
(b) micro-perforating the layer to form a plurality of spaced-apart perforations defining a total open orifice area, wherein the total open orifice area comprises about 0.1% to 99.9% of the total surface area of the layer.

22. A method of making a micro-perforated laminae according to claim 19, wherein the step of providing a layer of material comprises providing a layer of thermoplastic material, and the step of micro-perforating the layer comprises micro-perforating the thermoplastic layer to form a plurality of micro-slits having a length of about one millimeter each spaced-apart on the layer at a density per square area ranging from 10 cm centers to 0.5 mm centers, the micro-slits defining a total open orifice area comprising about 0.1% to 100.0% of the total surface area of the layer.
